(19) United States
(12) Patent Application Publication
(10) Pub. No.: US 2004/0039714 A1
(43) Pub. Date: Feb. 26, 2004

(54) Method for providing franking notes on postal items

(76) Inventors: Bernd Meyer, Konigswinter (DE); Jurgen Lang, Bergisch Gladbach (DE)

Correspondence Address: CONNOLLY BOVE LODGE & HUTZ, LLP, P O BOX 2207, WILMINGTON, DE, 19899, US

(21) Appl. No.: 10/258,230

(22) PCT Filed: Apr. 24, 2001
(86) PCT No.: PCT/DE01/01554

(30) Foreign Application Priority Data
Apr. 27, 2000 (DE) 100 20 402.3

(51) Int. Cl. G06F 17/00; G07B 17/02

(52) U.S. Cl. 705/408; 705/401

(57) ABSTRACT

The invention relates to a method for providing franking notes on postal items. The invention is characterized in that a credit information number (credit ID-CID) is formed in a loading station, encrypted and then sent to the customer system. The customer system stores the credit information number and the franking note is produced after inputting shipment data. Record of the franking note or notes produced is kept in the customer system.

The invention relates to a method for providing mailpieces with postage indicia, whereby a customer system controls the printing of postage indicia on mailpieces.

A method of this generic type is known from international patent application WO 98/14907.

Another method is known from German Patent No. DE 31 26 785 C2. With this method, a reloading signal intended for the franking of mailpieces is generated in a separate area of a value transfer center operated by a postal service provider.

The invention is based on the objective of creating a method for applying postage to letters that combines a high level of security of the postal service provider with the easiest possible handling by users.

According to the invention, this objective is achieved in that, in a loading station, a credit information number (Credit ID CID) is generated, encrypted and subsequently transmitted to the customer system, in that the customer system stores the credit identification number, in that postage indicia are generated after the mailing data has been entered and in that a journal is recorded in the customer system pertaining to the produced postage indicia and is provided with a digital signature.

In particular, the invention calls for carrying out a method for providing mailpieces with postage indicia in such a way that the customer first produces the postage indicia and that the produced postage indicia, especially the number thereof, is then recorded.

A major advantage here is that it is not necessary to load postage values but rather the actually produced postage values are always reported and charged after the fact. Thanks to the simplified process, a preferred embodiment of the method according to the invention (PCF credit) is particularly well-suited for companies with a medium to large mailing volume and an appropriate creditworthiness.

In order to increase the data security, it is advantageous for the journal of the postage indicia to be marked with a digital signature.

Additional advantages, special features and advantageous embodiments of the invention ensuc from the subordinate claims and from the presentation below of preferred embodiments making reference to the drawings.

The drawings show the following:

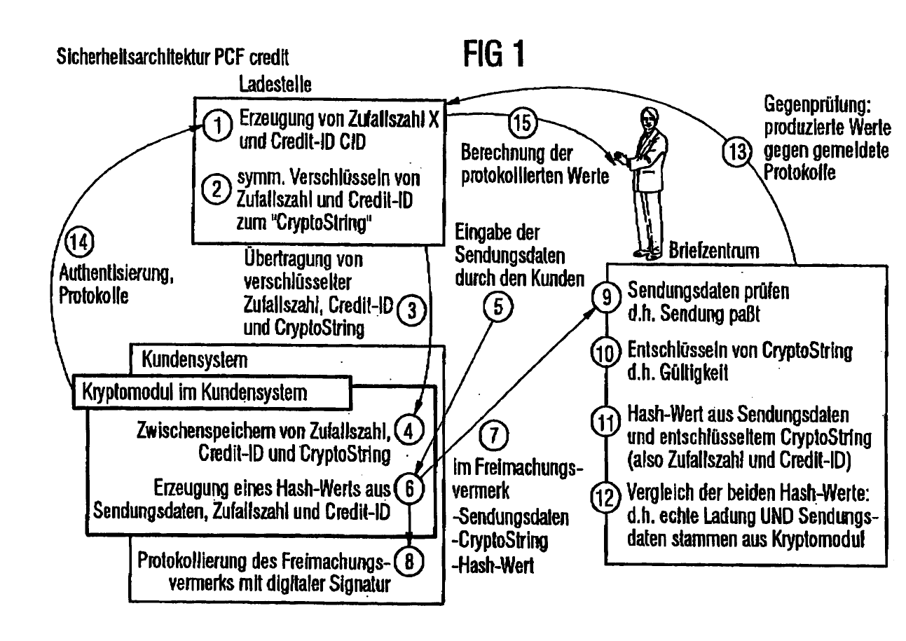

FIG. 1—a schematic diagram of security mechanisms used in a first embodiment of the method and

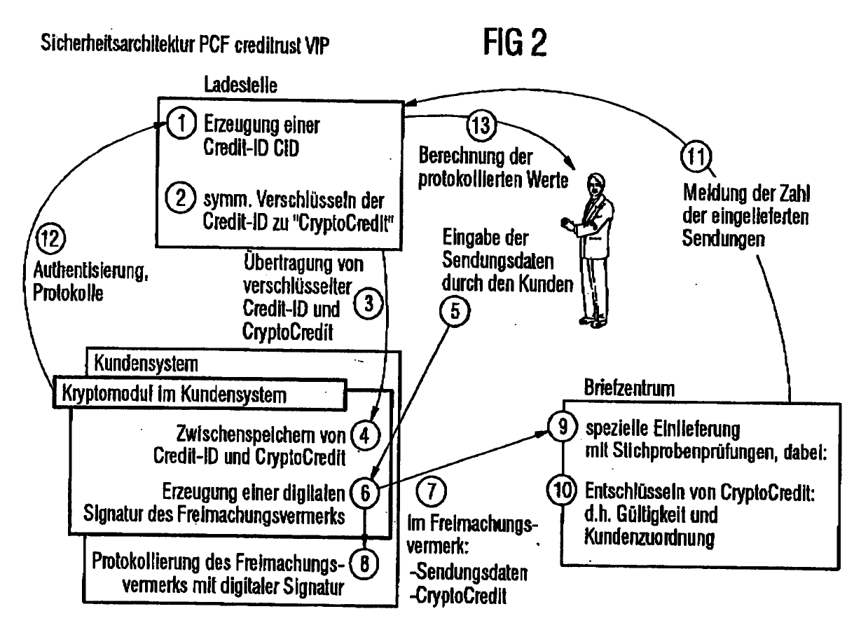

FIG. 2—a schematic diagram of security mechanisms used in another embodiment of the method.

The method comprises several steps that are carried out at differing frequencies. Individual processes such as generating a postage indicium are performed more frequently than other processes such as, for example, authentication of the customer system vis-á-vis a central loading station. Preferably, the loading procedure dcsignated below with reference numerals 1, 2, 3 and 4 takes place alter each authentication.

The production of the postage indicia preferably takes place separately from this loading procedure.

1. In the loading station, a random number X and a so-called Credit ID CID are generated that contain information about the customer, about his/her credit limit and about the period of validity of the CID (i.e. about the frequency of execution of the cyclic process).

2. In the loading station, the random number X and the Credit ID CD are encrypted (e.g. symmetrically) to form a so-called “CryptoString” in such a way that only the mail center is capable of decrypting the random number and the CID on the basis of this CryptoString.

3. The random number X, the Credit ID CID and the CryptoString are encrypted in such a way (e.g. asymmetrically) that only the crypto-module in the customer system is capable of decrypting his information.

4. The random number X, the Credit ID CID and the CryptoString are stored temporarily in the crypto-module in the customer system. Subsequently, the communication with the loading station can be terminated.

5. Within the scope of producing postage indicia, the customer enters mailing-specific information (e.g. parts of the address, postal code, value of postage, class of mailing etc.) into the crypto-module.

6. The crypto-module generates a hash value on the basis of, among other things, the mailing-specific data, the random number, the Credit ID CID (and optionally additional information).

7. The customer system generates a postage indicium that contains, among other things, the following information; the mailing data in plain text, the temporarily stored CryptoString and the generated hash value.

8. The crypto-module digitally signs the security-relevant information from the postage indicium with its own private key and stores it in a journal file in the customer system.

9. First of all, a verification of the plausibility is carried out in the mail center, for this purpose, the mailing-specific data of the postage indicium is compared to the properties of the mailing.

10. In another verification step, the CryptoString, which had been encrypted in such a manner that only the mail center could decrypt it, is decrypted to form the random number X and the Credit ID CID.

11. Like the customer system, the mail center now generates a hash value on the basis of, among other things, the mailing-specific data, the random number decrypted on the basis of the CryptoString and the Credit ID CID (and optionally additional information).

12. Through a comparison of the hash value that the mail center itself has just generated with the hash value received in the postage indicium, it is ascertained whether the (reliable) crypto-module in the customer system was indeed used to produce the postage indicium, thus confirming the validity of the postage indicium.

13. In a countercheck procedure, the produced values (processed in the mail center) can be reported to the loading station.

14. The accounting of the produced postage indicia is carried out within the scope of the regular contact of the loading station by the customer system. In this process, the crypto-module in the customer system is authenticated. In this context, the digitally signed journal data recorded under Item 8 is transmitted to the loading station.

15. The transmitted journal data is used in order to invoice the customer for the produced postage indicia. After the transmission of the journal data in Item 14, it is possible to begin again with Item 1, that is to say, with the preparation of a new random number X and a new Credit ID CID.

Below, with reference to FIG. 2, a variant of the method according to the invention will be presented which stands out for its simplified execution. The simplification entails advantages in terms of the possible speed of production of postage indicia at the premises of the customer. In order to compensate for the potentially lower security level that can be achieved with this method of applying postage, a special drop-off modality is necessary (e.g. elimination of anonymous dropping off in a mailbox) with which the dropped-off volume of mail can be ascertained. Together with a special creditworthiness status of the customer, this method is especially well-suited for large and very large volumes of mail.

The process shown in FIG. 2 is preferably a cyclic process that is executed regularly, e.g. daily. The actual start of the cyclic process is the step of authentication of the customer system at a central “loading station”, said step being designated in the figure with the numeral 12. For reasons of simpler depiction, the cyclic process in this depiction only starts with the first process step once the authentication has been successfully completed:

1. In the loading station, a so-called Credit ID CID is formed which contains information about the customer, about his/her credit limit and about the period of validity of the CID (i.e. about the frequency of execution of the cyclic process).

2. In the loading station, the Credit D CID is encrypted to form a so-called “CryptoCredit” in such a way (e.g. symmetrically) that only the mail center is capable of decrypting the CID) or the basis of this CryptoCredit.

3. The Credit W CID and the CryptoCredit are encrypted in such a way (e.g. asymmetrically) that only the crypto-module in the customer system is capable of decrypting this information.

4. The Credit ID CID and the CryptoCredit are stored temporarily in the crypto-module in the customer system. Subsequently, the communication with the loading station can be terminated.

5. Within the scope of producing a postage indicium, the customer enters mailing-specific information (e.g. parts of the address, postal code, value of postage, class of mailing, etc.) into the crypto-module.

6. The crypto-module generates a digital signature for the security-relevant information, which is also incorporated into the postage indicium (see Item 7).

7. The customer system generates a postage indicium that contains, among other things, the following information: the mailing data in plain text and the temporarily stored CryptoCredit.

8. The crypto-module digitally signs the security-relevant information from the postage indicium with its own private key and stores it in a journal file in the customer system.

9. The mailed volume is ascertained in the mail center after it has been dropped off there. Random samples can be taken from the dropped off mail in order to verify its validity.

10. Within the scope of a simplified validity verification, the CryptoCredit, which was encrypted in such a way that only the mail center could decrypt it, is decrypted to form the Credit ID CID. In this manner, the validity of the Credit ID and the assignment to the registered customer can be verified.

11. For purposes of counterchecking, the number of dropped off mailpieces is reported to the loading station.

12. The accounting of the produced postage indicia is carried out within the scope of the regular contact of the loading station by the customer system In this process, the crypto-module in the customer system is authenticated. In this context, the digitally signed journal data recorded under Item 8 is transmitted to the loading station.

13. The transmitted journal data is used to invoice the customer for the produced postage indicium. After the transmission of the journal data in Item 12, it is possible to begin again with Item 1, that is to say, with the preparation of a new random number X and a new Credit ID CID.

The methods according to the invention allow a franking of mailpieces with the greatest possible user-friendliness for the user and with a high payment security for the postal service provider.

1. A method for providing mailpieces with a postage indicium, whereby a customer system controls the printing of postage indicia on mailpieces, characterized in that, in a loading station, a credit information number (Credit ID CID) is generated, encrypted and subsequently transmitted to the customer system, in that the customer system stores the credit identification number, in that the postage indicium is generated after the mailing data has been entered and in that a journal is recorded in the customer system pertaining to the produced postage indicium and/or the produced postage indicia.

2. The method according to claim 1, characterized in that the journal of the postage indicium is marked with a digital signature.
